(19) United States
(12) Patent Application Publication
(10) Pub. No.: US 2026/0134073 A1
(43) Pub. Date: May 14, 2026

(54) Integrated Multifactor Credential Reader Incorporating Real Time Face Authentication

(71) Applicants: Martin J Janiak, Middleton, MA (US); Kevin C Booth, Verona, WI (US); Mark R Depp, Middleton, WI (US)

(72) Inventors: Martin J Janiak, Middleton, MA (US); Kevin C Booth, Verona, WI (US); Mark R Depp, Middleton, WI (US)

(21) Appl. No.: 18/947,925

(22) Filed: Nov. 14, 2024

(51) Int. Cl. G06F 21/32

(52) U.S. Cl. CPC G06F 21/32

(57) ABSTRACT

The Integrated Multifactor Credential Reader Incorporating Real Time Face Authentication device provides an electronic method of verifying that a person presenting a credential to gain access to a controlled area is the rightful owner of that credential. The verification is accomplished by matching a digital facial image stored on the credential to a live facial image of the person eliminating the need for a manual comparison of a person to a picture.

### CROSS REFERENCE TO RELATED APPLICATIONS

This application claims the benefit of Applicants'prior provisional application, No. 63/599,291 filed on Nov. 14 2023.

### BACKGROUND OF THE INVENTION

Identity verification is the process of determining that an individual is who they claim to be.

Credential based identity verification allows this process to be performed using a secure set of data stored on a credential instead of a centralized data base.

A credential could be a physical object such as a smart card or a derived object stored in a electronic device such as cell phone.

Access control systems require identity verification to confirm the individual presenting the credential is the authorized holder of that credential.

Typical methods of biometric identity verification include visually confirming an individual looks like their printed image, visual confirmation of a signature, or matching a live fingerprint to a stored fingerprint.

Current access control systems utilize a credential issued by a trusted authority to provide the data set necessary to perform identity verification.

Credential based identity verification using facial image matching provides a unique and improved method of identity verification that is fast, reliable, and requires no physical contact between the user and the device.

Existing facial imaging systems are composed of separate components for the credential interface and the facial image acquisition and comparison. These systems require external wiring for interconnection and more physical space.

Existing facial imaging systems attempt to match a live facial image to an image stored in a database. This can identify an individual but does not verify the individual is the authorized holder of a credential.

### SUMMARY OF THE INVENTION

The device provides an improved method of biometric identity verification. Facial image matching requires no physical user interaction and is not prone to false rejection due to user error as with fingerprint matching.

Incorporation of all required components within a single enclosure improves security, reliability, ease of support, and cost versus individual components wired together.

Matching a live facial image with a digital image securely stored on a credential provides positive verification of ownership of the credential.

### BRIEF DESCRIPTION OF THE DRAWINGS

FIG. 1 illustrates the components incorporated to form the Integrated Multifactor Credential Reader.

FIG. 1-1 (Processor) represents the micro-processor and related electronics which control the device.

FIG. 1-2 (Credential Reader) represents the electronic and mechanical interfaces required to support one or more credential types.

FIG. 1-3 (Facial Image Processor) represents the electronic component that performs the facial image capture and matching.

FIG. 2 represents the complete device and is suitable for publication.

### DETAILED DESCRIPTION OF THE INVENTION

The device incorporates all components required to read a digitized image from a credential, acquire a live image, compare the live image to the digitized image, and communicate the result to an external access control system.

A credential could be a smart card based on ISO-IEC 7816 or ISO-IEC 14443 standards including those that conform to the requirements defined by the Federal Information Processing Standard (FIPS 201), or other digital devices utilizing near field communications (NFC).

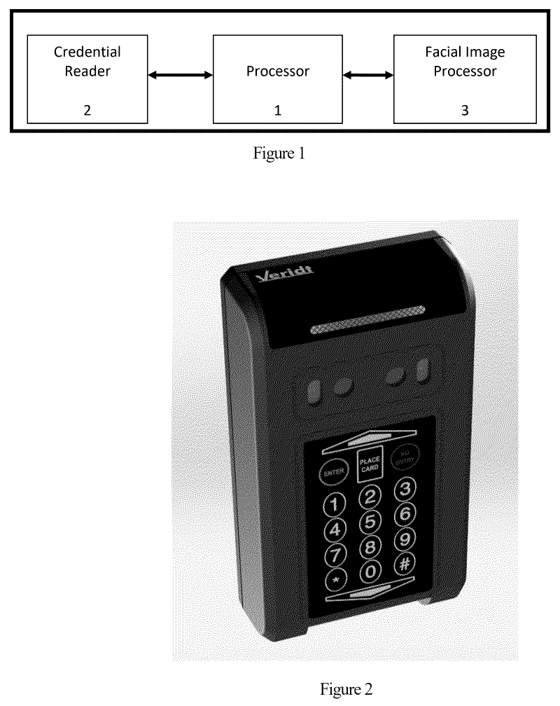

The device is typically operated as the card reader component of an access control system. When an individual desires access through a door or turnstile, their credential is presented to the device. The Processor (FIG. 1-1) reads the digitized facial image from the credential via the Credential Reader component (FIG. 1-2). The processor submits the digital image to the Facial Image Processor (FIG. 1-3). The Processor then commands the Facial Image Processor to acquire a live image and compare it to the digital image. The device communicates the result of the match attempt to the access control system.

What is claimed

1. The Invention claimed is a device that incorporates all components required to perform live facial image matching to a digital image stored on a credential within a single enclosure.

2. The Invention claimed is a single device capable of matching a live facial image to a digital image stored on a U.S. Government issued credential that conforms to the Federal Information Processing Standard (FIPS) 201.

3. The Invention claimed is a single device capable of matching a live facial image to a digital image stored on a credential.
